(19) United States
(12) Patent Application Publication
(10) Pub. No.: US 2026/0243376 A1
(43) Pub. Date: Aug. 20, 2026

(54) HOSE ROTATOR

(71) Applicant: GAMMON TECHNICAL PRODUCTS, INC., Manasquan, NJ (US)

(72) Inventors: James H. Gammon, Manasquan, NJ (US); Nicholas Charles Belluardo, Howell, NJ (US)

(21) Appl. No.: 19/642,179

(22) Filed: Apr. 8, 2026

Related U.S. Application Data
(63) Continuation-in-part of application No. 19/555,072, filed on Mar. 3, 2026.
Application No. 19/555,072 is a continuation of application No. 19/172,819, filed on Apr. 8, 2025.
(60) Provisional application No. 63/633,258, filed on Apr. 12, 2024.

(51) Int. Cl. F16L 27/08; F16L 15/08

(52) U.S. Cl. CPC F16L 27/0824; F16L 15/08

(57) ABSTRACT

A hose rotator includes a first coupling component and a second coupling component received in the first coupling component. The first coupling component is selectively rotatable with respect to the second coupling component. A release system is selectively disengaging a stationary rotational position of the first coupling component with respect to the second coupling component. A free-spin retaining member is selectively receivable in a bore to maintain a button in a depressed position, thereby permitting continuous free rotation of the first coupling component with respect to the second coupling component.

### CROSS REFERENCE TO RELATED APPLICATIONS

This application is a continuation-in-part of U.S. Pat. Appl. Ser. No. 19/555,072 filed March 3, 2026, which is a continuation patent application of U.S. Pat. Appl. Ser. No. 19/172,819 filed April 8, 2025, which claims the benefit of U.S. Provisional Application No. 63/633,258 filed on April 12, 2024. The entire disclosures of each of which are hereby incorporated herein by reference.

### FIELD OF THE INVENTION

The present invention relates to a hose reel and more particularly to a hose rotator or indexer having a free-spin feature for coupling a hose to the hose reel.

### BACKGROUND OF THE INVENTION

As known, a hose reel is utilized to ergonomically store and dispense a hose configured for supplying a fluid. The hose reel permits the hose to be selectively wound and unwound as desired and provides safety and space saving features for storing the hose. The hose can be configured for conveying any fluid such as fuel, water, gas, or any other fluid as desired.

Typically, hose reels have an inlet for receiving fluid from a fluid source and an outlet for connecting to the hose to convey the fluid from the hose reel to the hose. A swivel connect is generally employed at the inlet to permit the hose, or other coupling, to rotate with respect to the reel. However, the hose does not rotate at the outlet. In certain reels, the outlet is configured as a goose-neck type coupling. When the hose is installed onto the hose reel, the hose is oriented, rotationally about an axial direction, at a stagnant set point.

As a result, because the hose is rotationally stagnant at the outlet, the hose begins to wear on certain portions thereof, particularly on the portion of the hose that drags on the ground. Additionally, the positioning of the outlet, especially with respect to a height of the hose reel, is intentional as the position of the outlet permits a hose connection resulting in maximum flow and minimizes kinking and damage to the hose.

It is optimally desired to permit a simple rotation of the hose, periodically, to minimize wear on the hose without compromising the set positioning of the hose connecting on the hose reel and without having to disconnect the hose from the fluid outlet. It is also desired for a device that permits the hose to periodically rotate while minimizing kinking and restriction of fluid flow through the hose. Further, it is also desired for a device that permits continuous free rotation of the hose for extended periods without requiring the user to continuously apply force.

### SUMMARY OF THE INVENTION

Consistent and consonant with the present invention, a hose rotator permitting periodic rotation and continuous rotation of a hose with respect to a hose reel while maintaining efficient fluid flow and minimizing cost and complexity has surprisingly been discovered.

According to an embodiment of the disclosure, a hose rotator includes a first coupling component and a second coupling component received in the first coupling component. The first coupling component is selectively rotatable with respect to the second coupling component. A release system is selectively disengaging a stationary rotational position of the first coupling component with respect to the second coupling component. A free-spin retaining member is selectively receivable in a bore to maintain a button in a depressed position, thereby permitting continuous free rotation of the first coupling component with respect to the second coupling component.

According to another embodiment of the disclosure, a hose rotator coupling a hose to a fluid outlet is disclosed. The hose rotator includes a first coupling component configured to receive an end of a hose. The first coupling component has an annular extension. A second coupling component receives the annular extension of the first coupling component. The second coupling component is configured to be received in a fluid outlet. The first coupling component is rotationally stationary with respect to the second coupling component in each of a plurality of locked positions and rotationally movable with respect to the second coupling component in a freely rotatable position intermediate adjacent ones of the plurality of locked positions. A release system has a button cooperating with the first coupling component and the second coupling component to permit the second coupling component to rotate to the freely rotatable position.

According to another embodiment of the disclosure, a hose rotator including a first coupling component; a second coupling component, wherein the first coupling component is selectively rotatably received in the second coupling component; a release system configured to selectively disengage a stationary rotational position of the first coupling component with respect to the second coupling component, the release system including a button disposed in a bore of the first coupling component; and a retaining member selectively receivable in the bore to maintain the button in a depressed position, thereby disengaging the release system and permitting continuous free rotation of the first coupling component with respect to the second coupling component.

According to another embodiment of the disclosure, a hose rotator coupling a hose to a fluid outlet, the hose rotator including a first coupling component configured to receive an end of a hose; a second coupling component configured to be coupled to a fluid outlet, wherein the first coupling component is received in the second coupling component and is selectively rotatable with respect to the second coupling component between a plurality of locked positions and a freely rotatable position; a release system having a button cooperating with the first coupling component and the second coupling component to permit selective transition between the plurality of locked positions and the freely rotatable position; and a retaining member selectively engageable with the first coupling component to maintain the release system in a disengaged state, thereby permitting continuous free rotation of the first coupling component with respect to the second coupling component.

According to yet another embodiment of the disclosure, a method of selectively rotating a hose with respect to a fluid outlet, the method including providing a hose rotator having a first coupling component received in a second coupling component, the hose rotator including a release system with a button and a retaining member; actuating the button to disengage the release system and permit relative rotation of the first coupling component with respect to the second coupling component; rotating the first coupling component with respect to the second coupling component; and selectively engaging the retaining member to maintain the release system in a disengaged state, thereby permitting continuous free rotation of the first coupling component with respect to the second coupling component.

As aspects of some embodiments, the first coupling component includes a flange and an annular extension and the second coupling component includes a flange and an annular extension, wherein the annular extension of the first coupling component is axially aligned with and received in the second coupling component.

As aspects of some embodiments, the annular extension of the first coupling component includes an inner threaded portion configured to receive an end of a hose, and the annular extension of the second coupling component includes an outer threaded portion configured to be received in a fluid outlet.

As aspects of some embodiments, the bore includes internal threads and the retaining member is externally threaded configured to be threadably received in the bore.

As aspects of some embodiments, the retaining member includes a head portion and a stem portion, wherein the head portion is configured for manual or tool engagement.

As aspects of some embodiments, the release system further includes at least one detent and at least one biasing member, the at least one biasing member biasing the at least one detent toward the bore to define at least one locked position.

As aspects of some embodiments, the second coupling component includes a plurality of apertures, each of the apertures receiving one of the at least one detent and a corresponding one of the at least one biasing members.

As aspects of some embodiments, the apertures are disposed at equal angular intervals about a flange of the second coupling component.

As aspects of some embodiments, the apertures are disposed at an angle in a range of 30 degrees to 180 degrees from each other.

As aspects of some embodiments, a plurality of ball bearings disposed between the first coupling component and the second coupling component to facilitate rotation therebetween.

As aspects of some embodiments, a set screw received in a threaded bore of the second coupling component to retain the ball bearings.

As aspects of some embodiments, a seal disposed between the first coupling component and the second coupling component.

As aspects of some embodiments, the first coupling component includes a flange having a bore, and the retaining member is configured to be received in the bore to maintain the button in a depressed position.

As aspects of some embodiments, the first coupling component includes an annular extension with an inner threaded portion and the second coupling component includes an annular extension with an outer threaded portion.

As aspects of some embodiments, the release system includes a plurality of detents and a plurality of biasing members, each of the biasing members biasing a corresponding one of the detents toward the button of the release system to define the locked positions.

As aspects of some embodiments, a plurality of ball bearings disposed between the first coupling component and the second coupling component and a set screw configured to retain the ball bearings.

As aspects of some embodiments, disengaging the retaining member from the hose rotator to return the hose rotator to a plurality of locked positions.

### BRIEF DESCRIPTION OF THE DRAWINGS

The above advantages of the invention will become readily apparent to those skilled in the art from reading the following detailed description of an embodiment of the invention in the light of the accompanying drawings, in which:

FIG. 1 is a front perspective view of a hose reel according to an embodiment of the disclosure, with portions thereof removed for illustrative purposes;

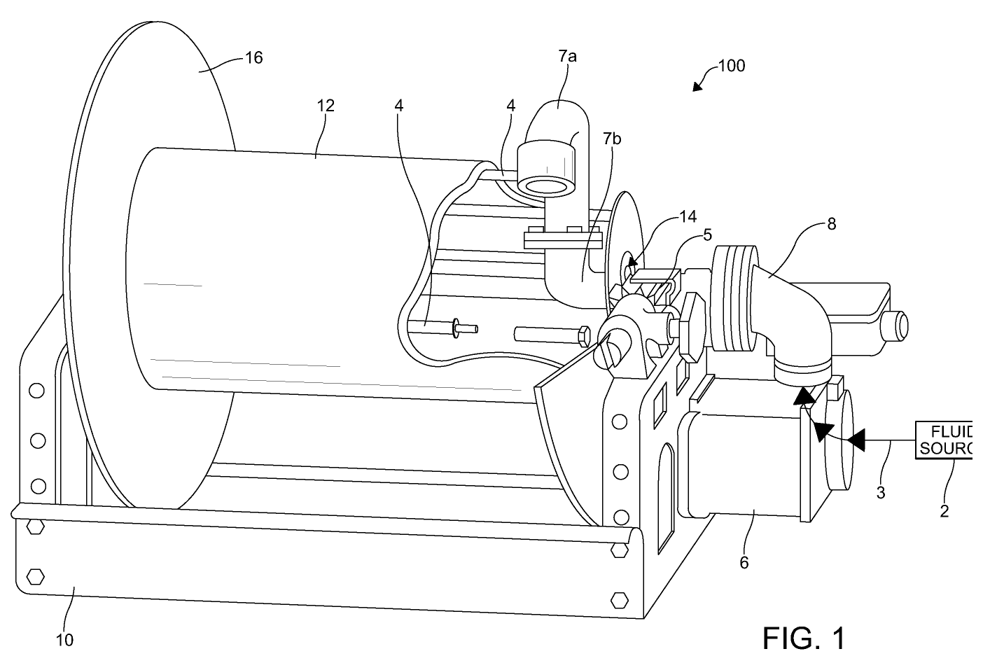

FIG. 2 is a fragmentary partially exploded front perspective view of a hose rotator configured for coupling to a conduit connector of the hose reel of FIG. 1;

FIG. 3 is an front perspective view of the hose rotator of FIG. 2;

FIG. 4 is an elevational cross-sectional view of the hose rotator of FIG. 3, taken lengthwise through cross-sectional line 4-4;

FIG. 5 is an elevational cross-sectional view of the hose rotator of FIG. 3, taken lengthwise through cross-sectional line 5-5;

FIG. 6 is an enlarged fragmentary elevational view of the hose rotator of FIG. 4, highlighted by circle 6;

FIG. 7 is a cross-sectional top plan view of the hose rotator of FIGS. 3, taken through cross-sectional line 7-7;

FIG. 8 is a bottom plan view a first coupling component of the hose rotator of FIG. 3;

FIG. 9 is a bottom plan view of a second coupling component of the hose rotator of FIG. 3;

FIG. 10 is a partially exploded front perspective view of a hose reel, a hose, and a hose rotator and a retaining member according to another embodiment of the disclosure, with portions thereof removed for illustrative purposes;

FIG. 11 is a side perspective view of the hose rotator and the retaining member of FIG. 10;

FIG. 12 is a front perspective view of the hose rotator of FIG. 10;

FIG. 13 is an elevational view of the hose rotator of FIG. 10;

FIG. 14 is a top perspective view of the hose rotator of FIG. 10;

FIG. 15 is an elevational cross-sectional view of the hose rotator of FIG. 14, taken lengthwise through cross-sectional line 14-14;

FIG. 16 is an enlarged fragmentary elevational cross-sectional view of the hose rotator of FIG. 15 and an elevational cross sectional view of the retaining member of FIG. 11, taken lengthwise through cross-sectional line 11-11, showing the retaining member as being removed from the hose rotator; and

FIG. 17 is an enlarged fragmentary elevational cross-sectional view of the hose rotator of FIG. 15 and an elevational cross sectional view of the retaining member of FIG. 11, taken lengthwise through cross-sectional line 11-11, showing the retaining member as being selectively replaced within the hose rotator.

### DETAILED DESCRIPTION OF THE PREFERRED EMBODIMENT

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

This disclosure relates to hose reels and hoses such as industrial type hose reels for supplying and conveying fluid such as fuel for fuel handling system. For example, the hose reels and hoses may be employed to supply fuel for aviation systems. However, it is understood, the disclosure can relate to any hose reel and hose systems used to convey any fluid such as any fuel, water, gas, or any other fluid that hoses are employed to convey.

For illustration purposes, a hose reel 100 configured for efficiently storing and dispensing a dispensing hose (not shown) is shown. The hose reel 100 includes a frame 10 for receiving a cylindrical drum 12. The drum 12 is rotatably coupled to the frame 10 by a rotation permitting apparatus 14 (generally indicated), such as a bearing housing for example, disposed at opposing ends of the drum 12. The drum 12 includes a pair of discs 16 (only one is shown) disposed at each of opposing ends of the drum 12 to maintain and guide the hose on the drum 12. Tie rods 4 join the discs 16 and the drum 12. A motor 6 and drive mechanisms 5 are in mechanical communication with the drum 12 to provide rotation to the drum 12. Although, it is understood any driving mechanism can be employed. Also, a manual forced rotation can also be applied to the drum 12 to rotate the drum 12. A fluid source conduit 3 (indicated by the line with arrows), such as a hose, for example, connects a fluid source 2 to an inlet 8 of the hose reel 100. The inlet 8 is configured as a swivel joint inlet 8 to permit the fluid source conduit 3 to rotate freely with respect to the hose reel 100 while remaining rigidly connected to the fluid source 2. It is understood the inlet 8 can be any type of inlet or rigid or non-rigid joint as desired without departing from the scope of the disclosure. A fluid hub 7b provides fluid communication between the inlet 8 and a fluid outlet 7a. The fluid outlet 7a is configured for connecting to an inlet end of a hose (not shown). The fluid outlet 7a is configured as a gooseneck type fitting to facilitate desired flow rates and to ensure the inlet end of the hose remains off the ground or other surface.

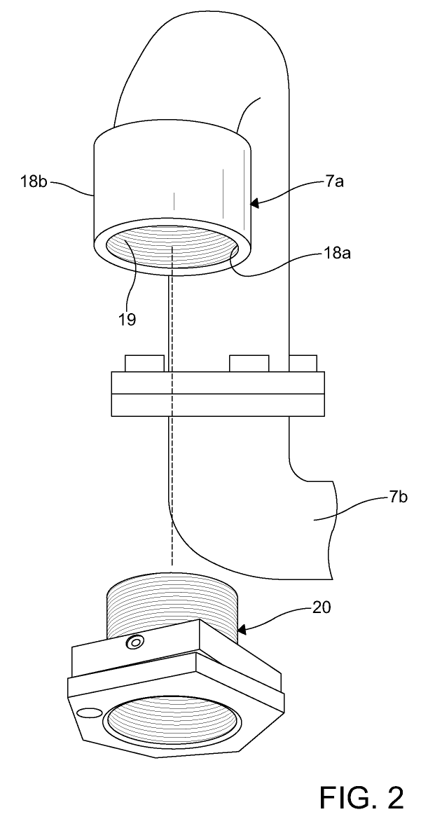

FIG. 2 illustrates a hose rotator 20 configured for coupling to the fluid outlet 7a of the hose reel 100. The fluid outlet 7a is substantially cylindrical having an inner surface 18a and an outer surface 18b. However, it is understood the fluid outlet 7a can have other shapes such as having an ovular cross-sectional shape, a rectangular cross-sectional shape, or any shape as desired. A threaded portion 19 is formed on the inner surface 18a of the fluid outlet 7a directly adjacent the end of the fluid outlet 7a. The threaded portion 19 is configured to receive and engage with an outer threaded portion 68 of the hose rotator 20 which will be described in further detail hereinbelow.

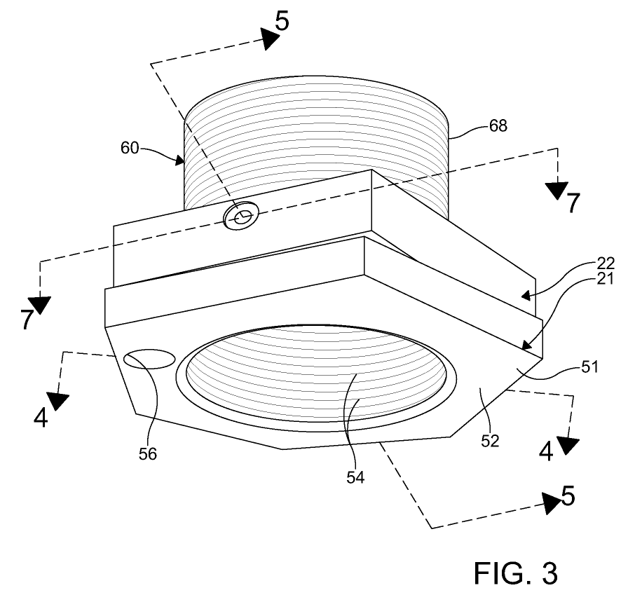

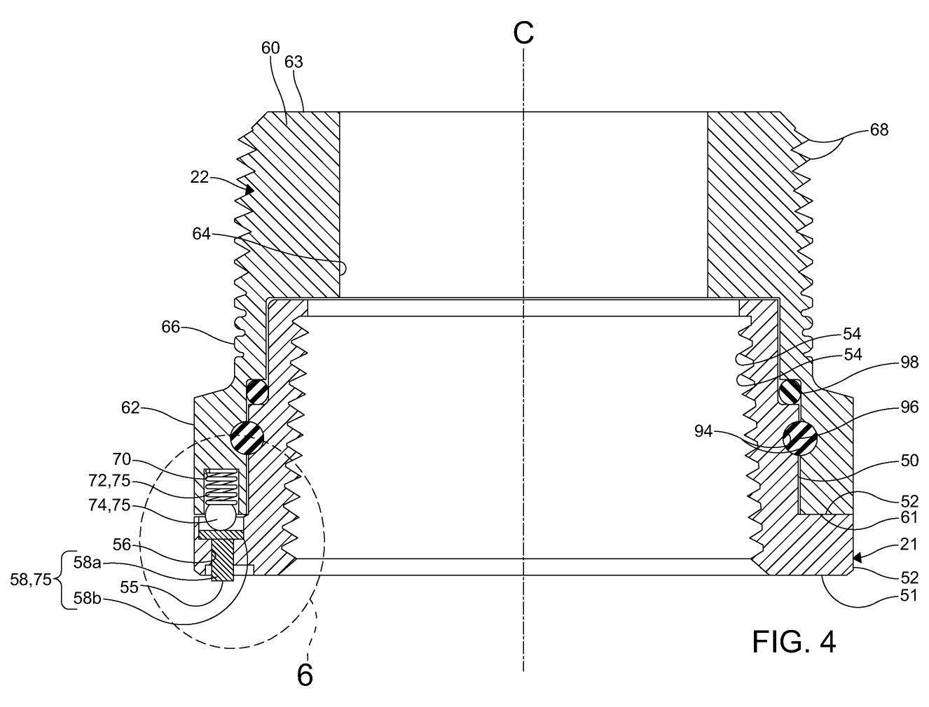

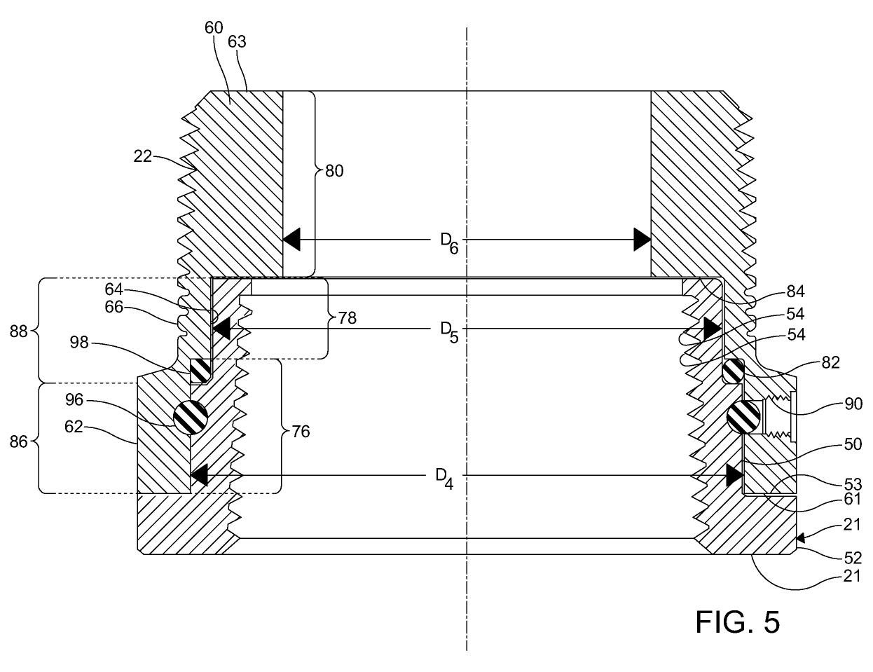

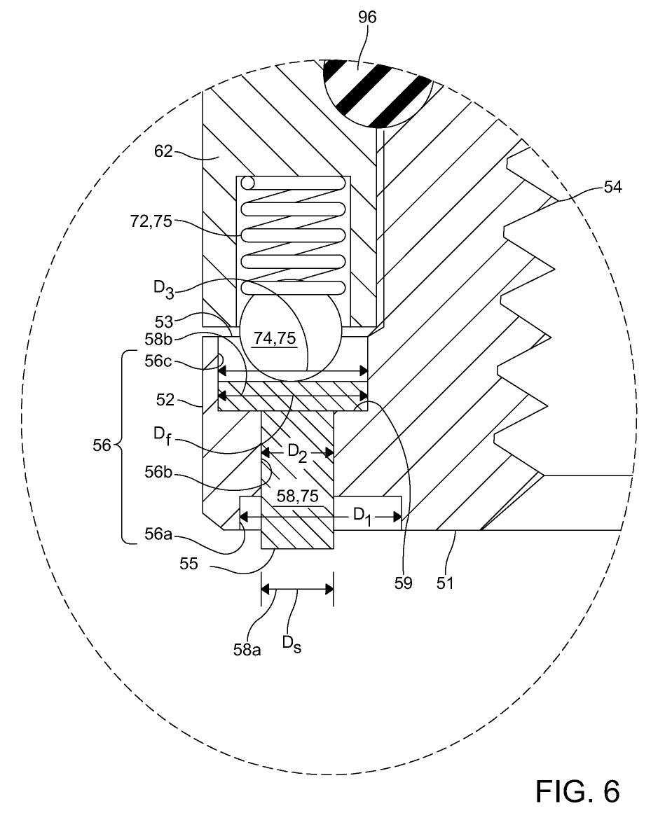

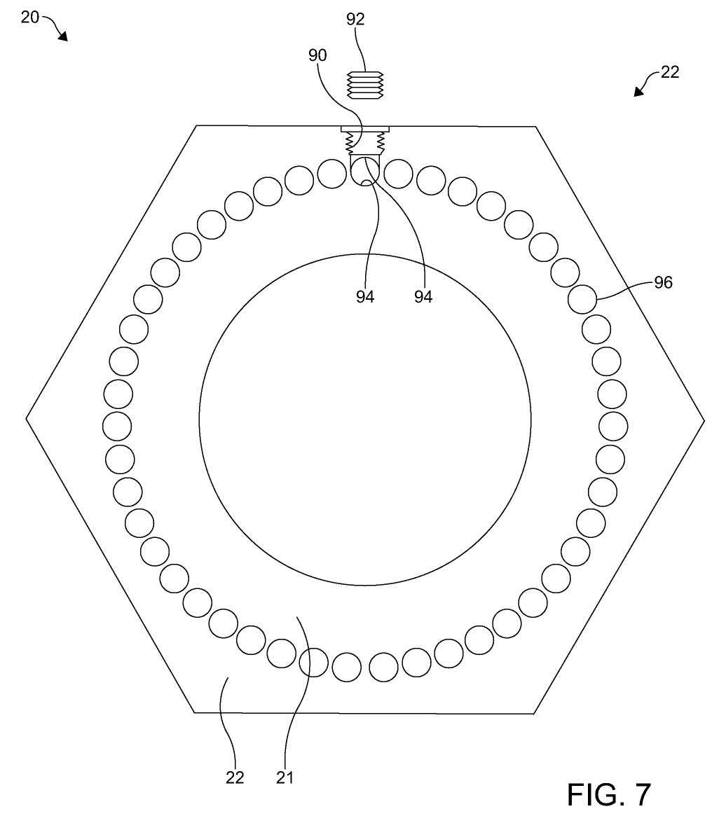

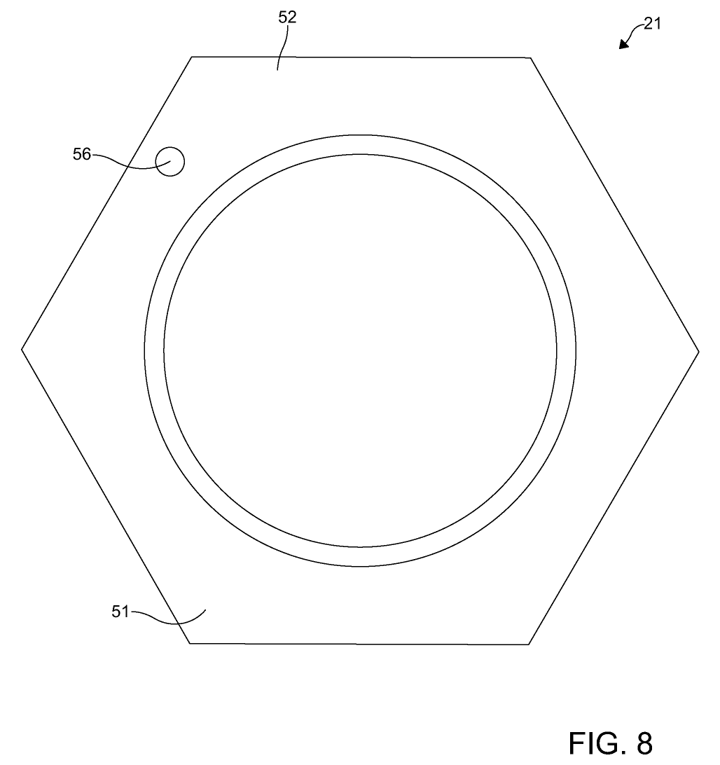

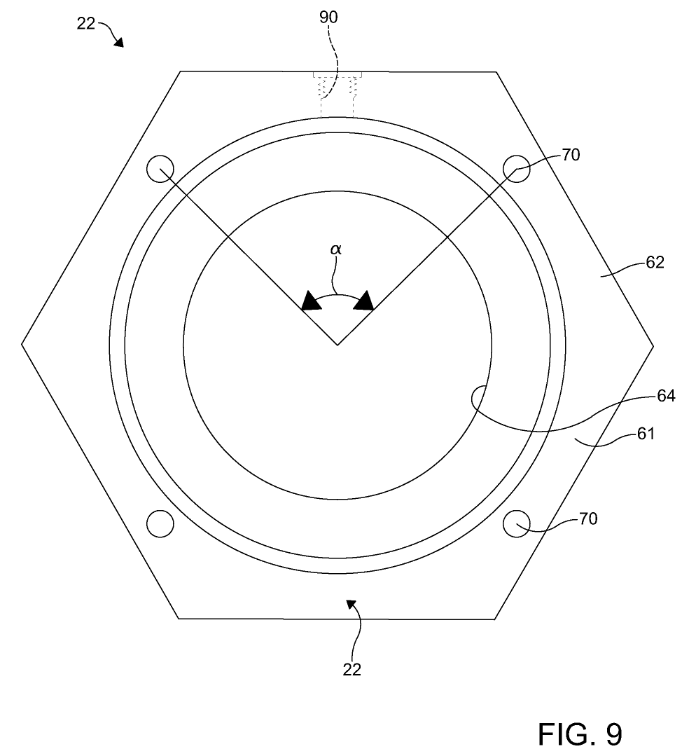

As shown in FIGS. 3-9, the hose rotator 20 includes a first coupling component 21 selectively rotatably coupled to and received in a second coupling component 22. The first coupling component 21 includes an annular extension 50 extending outwardly from a flange 52. The extension 50 includes an inner threaded portion 54 formed on an inner surface thereof. The inner threaded portion 54 is configured for engaging external threads formed on the desired dispensing hose (not shown). In another embodiment, the inner surface of the annular extension 50 can be non-threaded to receive a non-threaded end of another type of a dispensing hose, wherein a interference fit or alternate coupling device is employed to couple the dispensing hose to the first coupling component 21. The flange 52 has a substantially hexagonal cross-sectional shape to facilitate rotation of the first coupling component 21 with respect to the second coupling component 22. Although it is understood, the flange 52 can have other cross-sectional shapes as desired.

A single bore 56 is formed through the flange 52 to receive a rivet 58 therethrough. The bore 56 has a first inner surface 56a, a second inner surface 56b, and a third inner surface 56c. The first inner surface 56a, having a first inner diameter D₁, extends from an outer end surface 51 of the flange 52 in an axial direction towards the extension 50. The second inner surface 56b, having a second inner diameter D₂, extends intermediate the first inner surface 56a and the third inner surface 56c. The third inner surface 56c, having a third inner diameter D₃, extends from the second inner surface 56b of the bore 56 to an inner end surface 53 of the flange 52 opposing the first end surface 51 of the flange 52 adjacent the extension 50. The first inner diameter D₁ and the third inner diameter D₂ are greater than the second inner diameter D₂.

A rivet 58 is received in the bore 56. The rivet 58 includes a stem 58a with a diameter Dₛ and a flange 58b with a diameter D_{f} greater than the diameter Dₛ of the stem 58 and greater than the diameter D₂ of the second inner surface 56b. The rivet 58 is received in the bore 56 in a direction from the inner end surface 53 of the flange 52 of the first coupling component 21 to the outer end surface 51 of the flange 52 of the first coupling component 21. As such, the first inner surface 56a and the second inner surface 56b of the bore 56 receives the stem 58a and the third inner surface 56c receives the flange 58b of the rivet 58, wherein the flange 58b of the rivet 58 does not extend beyond the third inner surface 56c of the bore 56 into the second inner surface 56b of the bore 56.

The diameter D_{f} of the flange 58b of the rivet 58 is substantially equal to or less than the diameter D₃ of the third inner surface 56c but greater than the diameter D₂ of the second inner surface 56b. As a result, the flange 58b of the rivet 58 engages a shoulder 59 formed at an interface of the second inner surface 56b and the third inner surface 56c to militate against the flange 58b extending beyond the third inner surface 56c. When the flange 58b of the rivet 58 engages the shoulder 59, the stem 58a extends at a distance outwardly from the outer end surface 51 of the flange 52 of the first coupling component 21. As a result, the extension of the stem 58a outwardly from the outer end surface 51 of the flange 52 is configured as a button 55, wherein a user can apply pressure to the button 55 to activate a release system 75, which will be further discussed hereinbelow. The rivet 58 translates in an axial direction with respect to the bore between a first position wherein the stem 58a is configured as the button 51 and a second position wherein the flange 58b of rivet 58 aligns with the inner end surface and the stem 58a is received in the portion of the bore 56 at the third inner surface of the bore 56.

The second coupling component 22 includes a flange 62, an annular extension 60 extending outwardly from the flange 62, an inner surface 64, and an outer surface 66. The second coupling component 22 includes a planar first end surface 61 and a second end surface 63 axially opposing the first end surface 61. The flange 62 of the second portion 22 has a substantially hexagonal cross-sectional shape to facilitate rotation of the second coupling component 22 with respect to the first coupling component 21. The outer surface 66 of the annular extension 60 includes an outer threaded portion 68. The outer threaded portion 68 is configured to engage the inner threaded portion 19 formed on the inner surface 18a of the fluid outlet 7a of the hose reel 100.

A plurality of apertures 70 are formed in the first end surface 61 of the flange 62 of the second coupling component 22. As shown, there are four of the apertures 70 disposed at an angle α of about 90 degrees from each other about the flange 62. However, it is understood any number of apertures can be formed in the flange 62 and disposed at any angle at equal or unequal intervals as desired without departing from the scope of the disclosure. For example, the angle α can be 30 degrees, 45 degrees, 60 degrees, 180 degrees or any other angle as desired. The number of the apertures 70 can be 12, 8, 6, 4, or any number as desired. Each of the apertures 70 are disposed at about equal radial distances with each other from an axial center C of the hose rotator 20. The radial distance of each of the apertures 70 from the axial center C of the hose rotator 20 is about equal to the radial distance of the bore 56 of the first coupling component 21 from the axial center C of the hose rotator 20. As a result, depending on the rotational position of the first coupling component 21 with respect to the second coupling component 22, each of the apertures 70 can selectively align with the bore 56 upon a relative rotation of the first coupling component 21 with respect to the second coupling component 22.

Each of the apertures 70 receive a biasing member 72 and a detent 74. The detent 74 may be of any shape or size as desired. In an exemplary embodiment, and as described in the following disclosure, the detent 74 is configured as a ball 74 and has a spherical geometric shape. Each of the apertures 70 receive a biasing member 72 and a ball 74. The biasing member 72 is configured as a spring. However, the biasing member 72 can be any type of device or component that is configured to apply a constant force or pressure to another part and to exert a pre-set position or tension. The biasing member 72 of the present disclosure engages the ball 74 and biases in a direction towards the ball 74 and an opening end of the aperture 70.

The rivet 58, the biasing member 72, and the ball 74 cooperate together to form the release system 75 when the bore 56 of the first coupling component 21 rotates and aligns with one of the apertures 70 of the second coupling component 23. When the bore 56 aligns with one of the apertures 70, herein designated as the locked position of the hose rotator 20, the biasing member 72 biases the ball 74 towards the bore 56 so that the ball 74 at least partially extends into the bore 56. The ball 74 extends partially into the bore 56 causing rotational resistance between the first coupling component 21 and the second coupling component 22. As a result of the extension of the ball 74 into the bore 56, the ball 72 then engages the rivet 58 and transfers a spring force from the biasing member 72 to the rivet 58 in the first position to cause the rivet 58 to linearly translate to the second position to essentially “lock” the hose rotator 20 to militate from any relational rotation between the first coupling component 21 and the second coupling component 23.

The first coupling component 21 is configured to rotate between a locked position, wherein, in the locked position, one of the apertures 70 aligns with the bore 56 and the rivet 58 of associated with the aperture 70 is in the second position as described hereinabove. If there are four apertures, then the first coupling component 21 rotates between four locked positions. When the hose rotator 20 is not in one of the locked positions, the hose rotator 20 is in a freely rotatable position. When the hose rotator 20 is in the freely rotatable position, a force is applied to the rivet 58 which then transfers the force to the ball 74 and to the biasing member 72 of an aligned one of the apertures 70. The ball 74 is forced completely within the respective one of the apertures 70 directly between and engaging the respective biasing member 71 and the inner end surface 53 of the flange 52 of the second coupling component 22. As such, the first coupling component 21 can freely rotate with respect to the second coupling component 22 until the bore 56 aligns with an adjacent one of the apertures 70 and the ball 74 is biased into the bore 56 and the rivet 58 extends to the second position.

The extension 60 of the second coupling component 22 includes a first inner surface section 76, a second inner surface section 78, and a third inner surface section 80, each having a varying diameter. The diameter D₄ of the first inner surface section 76 is greater than the diameter D₅ of the second inner surface section 78 and the diameter of the second inner surface section 78 is greater than the diameter D₆ of the third inner surface section 80. The inner surface sections 76, 78, 80 cooperate to form a first stop 82 and a second stop 84. The first inner surface section 76 is configured to receive an intermediate first portion 86 of the extension 50 of the first coupling component 21 and the second inner surface section 78 is configured to receive a distal second portion 88 of the extension 50 of the first portion 21. The first stop 82 is configured to align and engage the intermediate first portion 86 when the first coupling component 21 is received in the second coupling component 22 to militate against movement of the intermediate first portion 86 in the axial direction beyond the first inner surface section 76. The second inner surface section 78 is configured to receive the distal second portion 88 of the extension 50 of the first coupling component 21. The second stop 84 engages the distal end of the extension 50 of the first coupling component 21 to militate against movement of the extension 50 in the axial direction beyond the second inner surface section 78.

An outer surface of the flange 62 of the second coupling component 22 includes an internally threaded bore 90 formed therein. The bore 90 is configured to receive a set screw 92. Corresponding and oppositely curved recesses 94 are circumferentially formed in the first inner surface section 76 of the second coupling component 22 and the outer surface of the first coupling component 21 to receive ball bearings 96 between the first coupling component 21 and the second coupling component 22 to facilitate rotation therebetween. The set screw 92, in some embodiments, is externally threaded and configured to be received in the bore 90 and engage the ball bearings 94 to assert a compressional force upon the ball bearings 96 and consequentially upon the first coupling component 21. As a result, the set screw 92 facilitates anti-rotation between the first coupling component 21 and the second coupling component 22. In other embodiments, the set screw 92 is externally threaded and configured to be received in the bore 90 to retain the ball bearings 94 within the second coupling component 22. A seal 98 is disposed between the first coupling component 21 and the second coupling component 22 at the first stop 82 to militate against leakage.

To assemble the hose rotator 20, the first coupling component 21 is received in the second coupling component 22. The first coupling component 21 is rotated until the bore 56 and the rivet 58 align with one of the plurality of apertures 70. Once the bore 56 and the one of the plurality of apertures 70 is aligned, the biasing member 72, which biases towards the top surface of the flange 52 of the first portion 21, forces the ball bearing 74 into the bore 56 to prevent rotation of the first coupling component 21 with respect to the second coupling component 22. The set screw 92 is threaded into the bore 90 and, in some embodiments, also facilitates in militating against rotational movement between the first coupling component 21 and the second coupling component 22.

In application, the annular extension 50 of the first coupling component 21 is coupled to the hose and the annular extension 60 of the second coupling component 22 is coupled to the fluid outlet 7a of the hose reel 100. In order to selectively rotate the hose with respect to the fluid outlet 7a of the hose reel 100, the set screw 92, in some embodiments, must be decoupled from the set screw bore 90. In other embodiments, the set screw 92 is retained within the set screw bore 90 while selectively rotating the hose with respect to the fluid outlet 7a of the hose reel 100. The rivet 58, ball bearing 74, and biasing member 72 cooperate with each other to form a releasing mechanism so the first coupling component 21 can be rotated with respect to the second coupling component 22. A force, by a user with a finger or tool, for example, is applied to the stem 58a in the first position to overcome the biasing force of the biasing member 72. When the force by the user is applied, the rivet 58 urges the ball bearing 74 downwardly into the respective aligning one of the apertures 70, to the second position, to disengage the ball bearing 74 from preventing rotational movement between the first coupling component 21 and the second coupling component 22. The hose rotator is now in the freely rotatable position. The first coupling component 21 can be rotated clockwise or counter-clockwise with respect to the second portion at about 45 degrees, or at any interval as desired, until one of the other apertures 70 aligns with the bore 56. Upon the alignment, the biasing member 72 of the adjacent aperture 70 urges the ball bearing 74 into the bore 56 of the first coupling component 21 and causes the rivet 58 to extend outwardly from the flange 52 of the first coupling component 21 so the first coupling component 21 can be rotated again, if desired. Once rotated as desired, the set screw 92, in some embodiments, can be received in the set screw bore 90 and engage the ball bearings 96 again.

As a result of the invention of the present disclosure, a hose can be rotated to minimize wear. The hose rotator 20 of the present disclosure permits the second coupling component 22 to remain in one position, without rotational movement, with respect to the fluid outlet of the hose reel 100, while allowing the first coupling component 21 to be rotatable with the hose selectively or periodically, while maintaining consistent fluid communication between he fluid outlet 7a and the hose. For example, as a maintenance task, the first coupling component 21 together with the hose can be rotated 45 degrees every three months to minimize wear and prolong the life of the hose. Although, the hose can be rotated at any time intervals as desired. The hose rotator 20 of the present disclosure is cost effective, simple, and can be fitted and modified to existing hose reels.

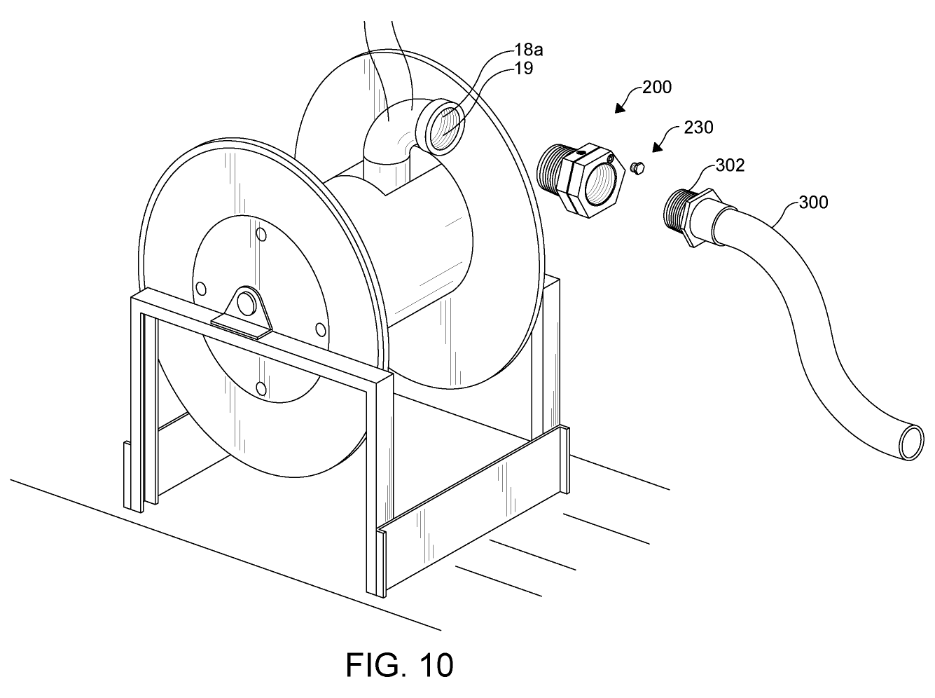

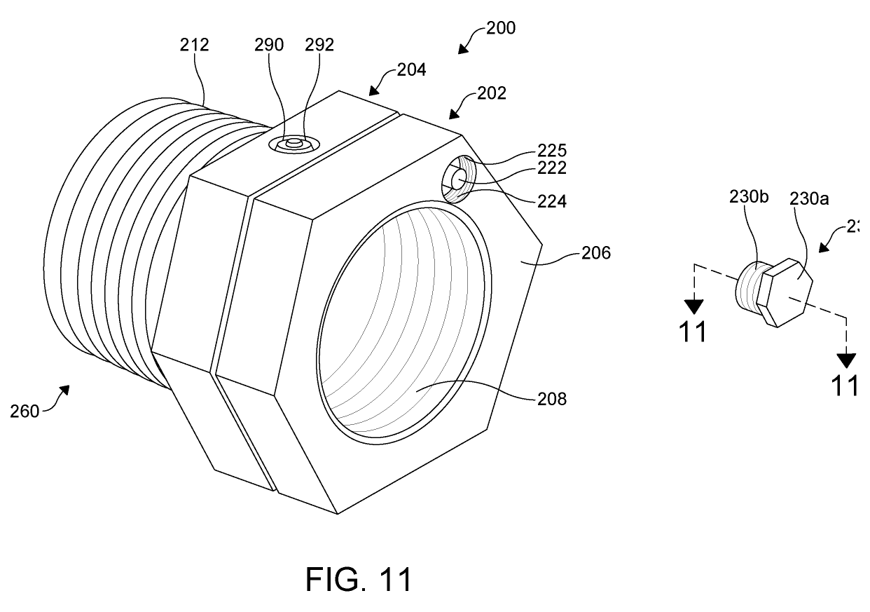

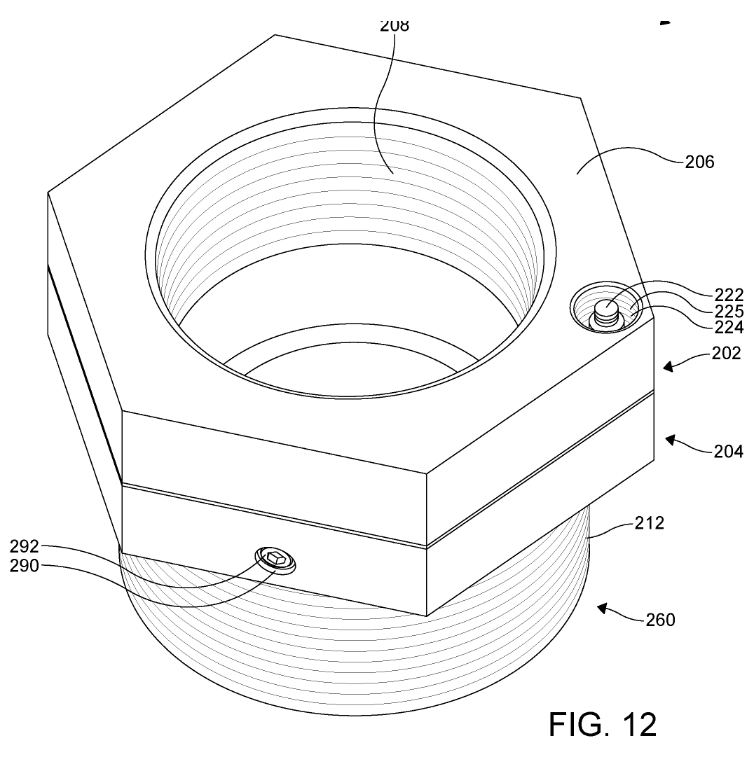

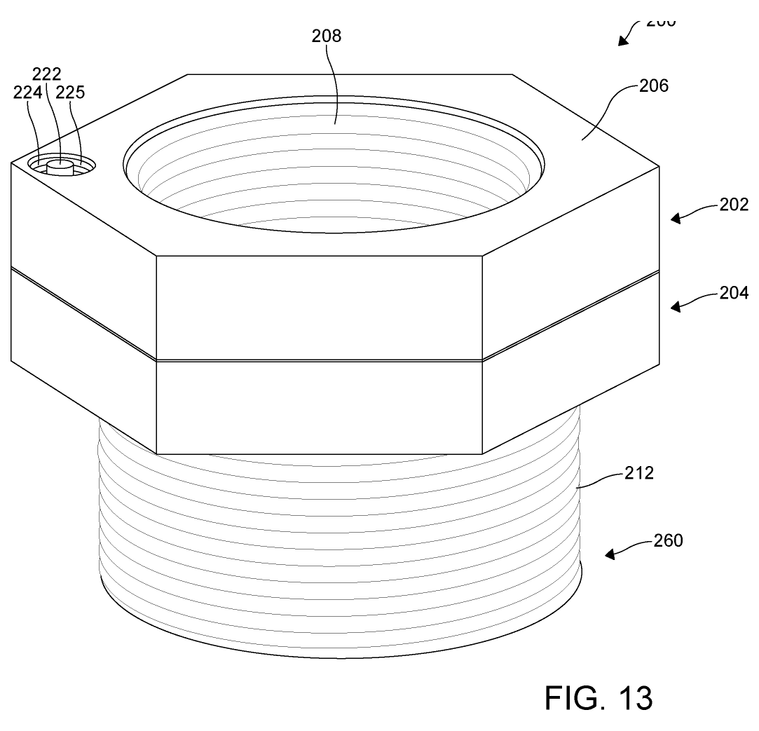

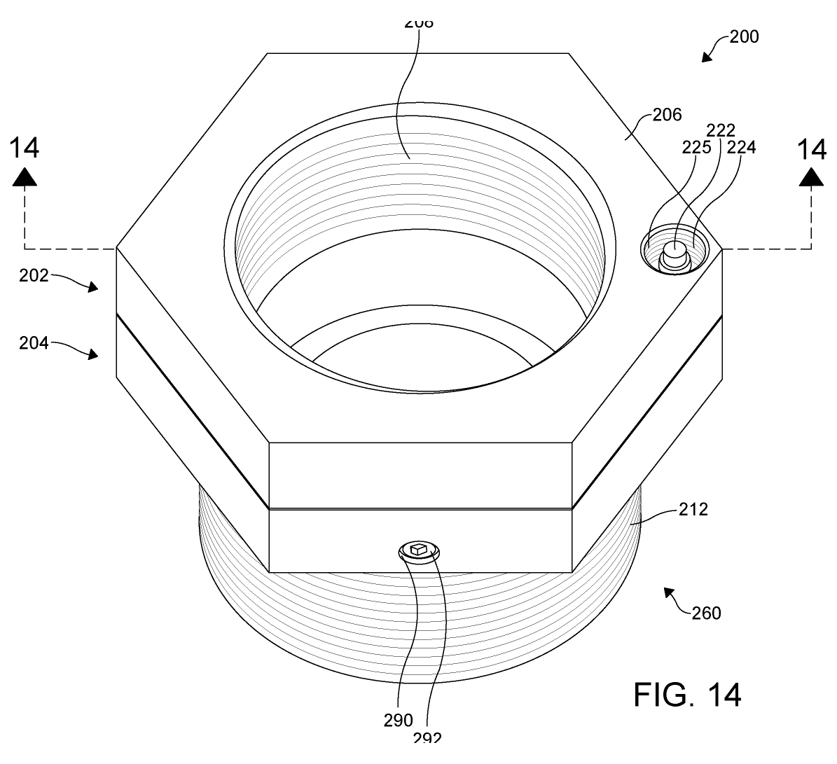

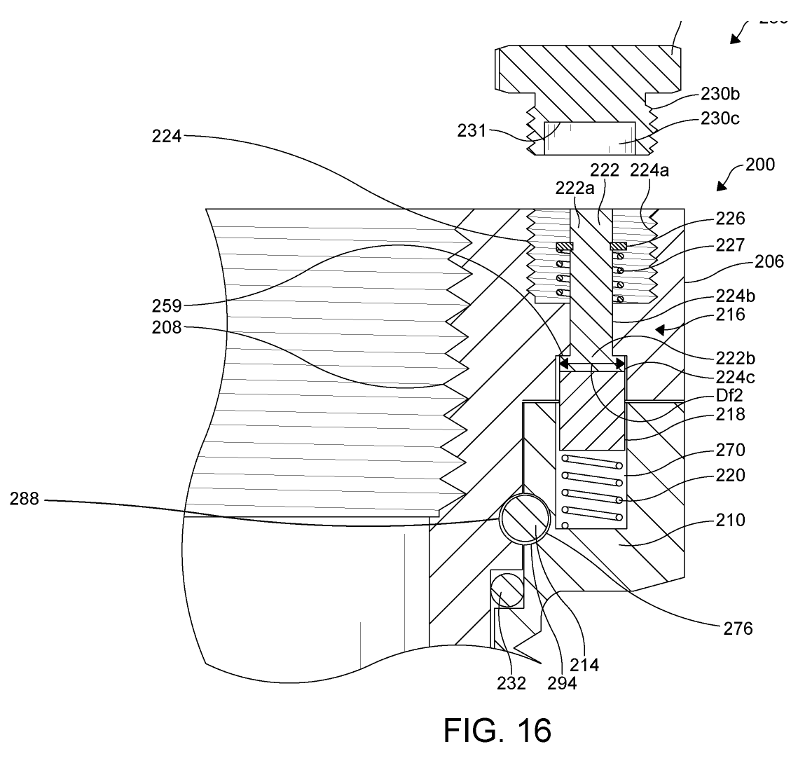

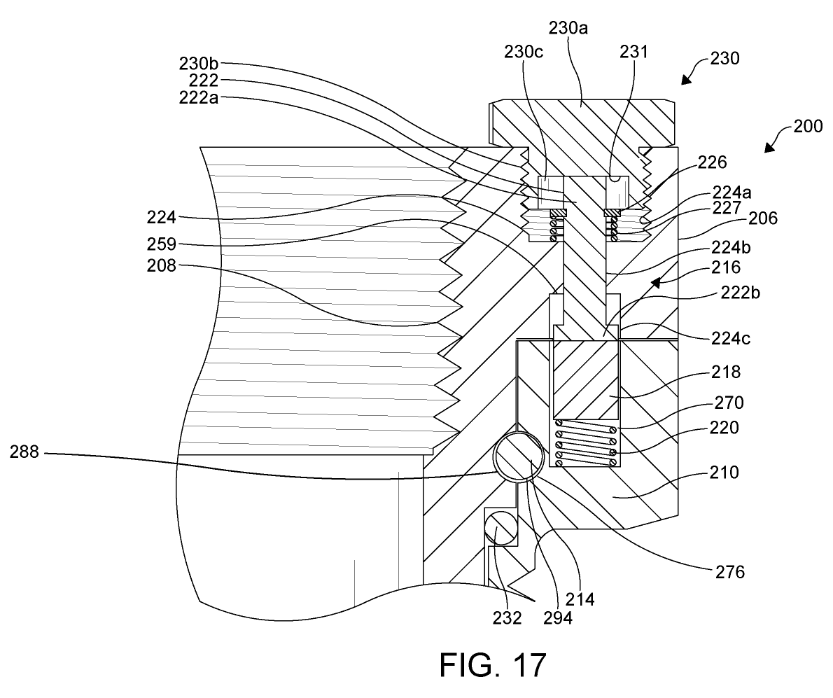

Referring now to FIGS. 10-17, a hose rotator 200 according to another embodiment of the disclosure is shown. The hose rotator 200 is configured as a rotating reducing bushing designed to simplify the installation, handling, and inspection of a fuel hose on a hose reel or swivel while extending the service life of the hose. In some aspects, the hose rotator 200 may be installed between a hose reel swivel or gooseneck, such as the fluid outlet 7a, and a dispensing hose 300 to enable the entire hose assembly to rotate.

The hose rotator 200 includes a first coupling component 202 selectively rotatably coupled to and received in a second coupling component 204. The first coupling component 202 includes an annular extension 250 extending outwardly from a flange 206. The annular extension 250 includes an inner threaded portion 208 formed on an inner surface thereof. The inner threaded portion 208 is configured for engaging external threads 302 formed on the dispensing hose 300. In another embodiment, the inner surface of the annular extension 250 can be non-threaded to receive a non-threaded end of another type of a dispensing hose 300, wherein an interference fit or alternate coupling device is employed to couple the dispensing hose 300 to the first coupling component 202. The flange 206 has a substantially hexagonal cross-sectional shape to facilitate rotation of the first coupling component 202 with respect to the second coupling component 204. Although it is understood, the flange 206 can have other cross-sectional shapes as desired. It is also understood that the inner threaded portion 208 can be configured to receive hoses of any diameter as desired.

The second coupling component 204 includes a flange 210, an annular extension 260 extending outwardly from the flange 210, an inner surface 264, and an outer surface 266. The second coupling component 204 includes a planar first end surface 261 and a second end surface 263 axially opposing the first end surface 261. The flange 210 of the second coupling component 204 has a substantially hexagonal cross-sectional shape to facilitate rotation of the second coupling component 204 with respect to the first coupling component 202. Although it is understood, the flange 210 can have other cross-sectional shapes as desired. The outer surface 266 of the annular extension 260 includes an outer threaded portion 212. The outer threaded portion 212 is configured to engage an inner threaded portion formed on an inner surface of a fluid outlet, such as the fluid outlet 7a of the hose reel 100. It is understood the outer threaded portion 212 can be configured to engage fluid outlets of any diameter as desired. As such, the hose rotator 200 may function as a reducing bushing that adapts between different thread sizes while incorporating rotational features.

Corresponding and oppositely curved recesses 294 are circumferentially formed in an inner surface section 276 of the second coupling component 204 and an outer surface 288 of the first coupling component 202 to receive a plurality of ball bearings 214 between the first coupling component 202 and the second coupling component 204 to facilitate rotation therebetween. In some embodiments, the plurality of ball bearings 214 may include fifty-six ball bearings arranged circumferentially within the recesses 294. However, it is understood any number of ball bearings can be employed as desired. The ball bearings 214 provide smooth rotational movement between the first coupling component 202 and the second coupling component 204. An outer surface of the flange 210 of the second coupling component 204 includes an internally threaded bore 290 formed therein. The bore 290 is configured to receive a set screw 292. The set screw 292 is externally threaded and configured to be received in the bore 290 to retain the ball bearings 214 within the recesses 294. A seal 232, such as an O-ring, is disposed between the first coupling component 202 and the second coupling component 204 to militate against leakage and provide a fluid-tight seal during rotation. In some embodiments, the seal 232 may be formed from an elastomer. However, it is understood any suitable sealing material can be employed as desired.

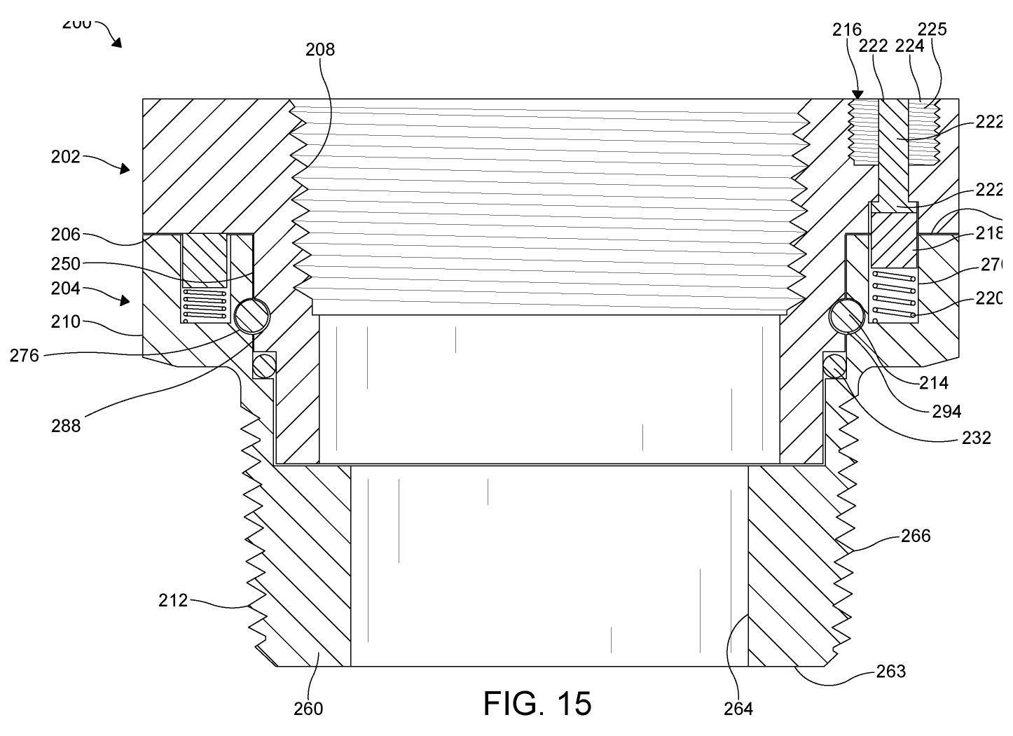

One or more apertures 270 are formed in the first end surface 261 of the flange 210 of the second coupling component 204. As illustrated in FIG. 15, there are six of the apertures 270 disposed at an angle of about 60 degrees from each other about the flange 210. However, it is understood any number of apertures can be formed in the flange 210 and disposed at any angle at equal or unequal intervals as desired without departing from the scope of the disclosure. For example, the angle can be 30 degrees, 45 degrees, 90 degrees, 180 degrees or any other angle as desired. The number of the apertures 270 can be 12, 8, 6, 4, or any number as desired. Each of the apertures 270 are disposed at about equal radial distances with each other from an axial center of the hose rotator 200. Each of the apertures 270 receive a biasing member 220 and a detent 218. The detents 218, in an exemplary embodiment, have a substantially cylindrical geometric shape. However, it is understood the detents 218 can have other geometric shapes such as spherical, conical, or any shape as desired. The biasing member 220, in an exemplary embodiment, is configured as a spring. However, the biasing member 220 can be any type of device or component that is configured to apply a constant force or pressure to another part and to exert a pre-set position or tension. The biasing member 220 of the present disclosure engages the detent 218 and biases in a direction towards the detent 218 and an opening end of the aperture 270.

In an exemplary embodiment, and as illustrated best by FIGS. 10-17, a single bore 224 is formed through the flange 206 of the first coupling component 202. The bore 224 has a first inner surface 224a, a second inner surface 224b, and a third inner surface 224c. The first inner surface 224a, having a first inner diameter, extends from an outer end surface of the flange 206 in an axial direction towards the annular extension 250. The second inner surface 224b, having a second inner diameter, extends intermediate the first inner surface 224a and the third inner surface 224c. The third inner surface 224c, having a third inner diameter, extends from the second inner surface 224b of the bore 224 to an inner end surface of the flange 206. The bore 224 includes internal threads 225 formed on at least one of the inner surfaces thereof. The internal threads 225 are configured to receive an externally threaded retaining member 230.

A button 222 is received in the bore 224. The button 222 includes a stem 222a and a flange 222b with a diameter D_{f2} greater than the diameter of the stem 222a. The diameter D_{f2} of the flange 222b of the button 222 is substantially equal to or less than a diameter of the third inner surface 224c but greater than a diameter of the second inner surface 224b. As a result, the flange 222b of the button 222 engages a shoulder 259 formed at an interface of the second inner surface 224b and the third inner surface 224c to militate against the flange 222b extending beyond the third inner surface 224c. When the flange 222b of the button 222 engages the shoulder 259, the stem 222a extends at a distance outwardly from the outer end surface of the flange 206 of the first coupling component 202. As a result, the extension of the stem 222a outwardly from the outer end surface of the flange 206 is configured as the button 222, wherein a user can apply pressure to the button 222 to activate a release system 216, which will be further discussed hereinbelow. The button 222 translates in an axial direction with respect to the bore 224 between a first position wherein the stem 222a is configured as the button 222 and a second position wherein the flange 222b of button 222 aligns with the inner end surface and the stem 222a is received in the portion of the bore 224 at the third inner surface 224c of the bore 224.

In some embodiments, a retaining ring 226 and a biasing member 227 are also received in the bore 224. In an exemplary embodiment, the biasing member 227 is a compression spring. However, it is appreciated that the biasing member 227 may be any biasing member as desired. The retaining ring 226 and the biasing member 227 encircle the button 222, and particularly, the stem 222a of the button 222. The biasing member 227 is configured to provide resistance when the retaining member 230 is inserted into the bore 224. The retaining ring 226 engages the biasing member 227 and an upper surface 231 of a cavity 230c of the retaining member 230 to provide the resistance when the retaining member 230 is selectively inserted into the bore 224. However, it is understood that the retaining ring 226 and the biasing member 227 may be configured in any manner, and may take any form, as desired.

Both the biasing member 220 and the biasing member 227 bias the button 222 towards an extended position. The biasing member 227 acts cumulatively with the biasing member 220 by exerting an upward force on the retaining ring 226, and therefore the button 222. When a user applies a force to the button 222, while the hose rotator 200 is in a locked position, the button 222 is depressed against the bias of both the biasing member 220 and the biasing member 227 to disengage the release system 216, thereby permitting rotation of the first coupling component 202 with respect to the second coupling component 204. The button 222 is ordinarily in the extended position because the biasing member 227 coupled with the retaining ring 226 continuously exerts an upward force on the button 222. Because of this, when the hose rotator 200 is in a freely rotatable position and the button 222 is no longer engaging the detent 218, the user need only overcome the bias of the biasing member 227 to depress the button. The button 222 enables the user to disengage the release system 216 without requiring any tools.

The retaining member 230 includes a head portion 230a, a stem portion 230b, and a cavity 230c. The head portion 230ahas a substantially hexagonal cross-sectional shape to facilitate rotation of the retaining member 230 with a tool or by hand. Although it is understood, the head portion 230acan have other cross-sectional shapes as desired. The stem portion 230b, in an exemplary embodiment, is externally threaded and configured to engage the internal threads 225 formed in the bore 224. The cavity 230c is formed in the stem portion 230b, and is substantially cylindrical in geometrical shape in some embodiments. It should be appreciated, however, that the cavity 230c may have any geometric shape as desired. The cavity 230c, in some embodiments, may be configured to allow the retaining member 230 to be threaded within the bore 224 to a further extent than in embodiments lacking the cavity 230c.

When the retaining member 230 is threaded into the bore 224, an upper surface 231 of the cavity 230c of the stem portion 230b engages and maintains the button 222 in a depressed position, thereby disengaging the release system 216 and permitting continuous free rotation of the first coupling component 202 with respect to the second coupling component 204. As such, the retaining member 230 allows the hose rotator 200 to operate in a hands-free free-spin mode for as long as required. To return the hose rotator 200 to normal locked operation, the retaining member 230 is simply unthreaded from the bore 224.

The button 222, the biasing members 220, and the detents 218 cooperate together to form the release system 216 when the bore 224 of the first coupling component 202 rotates and aligns with one of the apertures 270 of the second coupling component 204. When the bore 224 aligns with one of the apertures 270, herein designated as the locked position of the hose rotator 200, the biasing member 220 biases the detent 218 towards the bore 224 so that the detent 218 at least partially extends into the bore 224. The detent 218 extends partially into the bore 224 causing rotational resistance between the first coupling component 202 and the second coupling component 204. As a result of the extension of the detent 218 into the bore 224, the detent 218 then engages the button 222 and transfers a spring force from the biasing member 220 to the button 222 to essentially “lock” the hose rotator 200 to militate against any relational rotation between the first coupling component 202 and the second coupling component 204.

The first coupling component 202 is configured to rotate between the locked position, wherein, in the locked position, one of the apertures 270 aligns with the bore 224. If there are six apertures, then the first coupling component 202 rotates between six locked positions. When the hose rotator 200 is not in one of the locked positions, the hose rotator 200 is in the freely rotatable position. When the hose rotator 200 is in the freely rotatable position, the button 222 has no contact with any of the detents 218 or biasing members 220. However, the button 222 is constantly in the extended position, unless the user applies a force to the button 222 to move the button 222 to the depressed position, because of the coupling of the button 222 to the biasing spring 227 and the retaining ring 226. When the hose rotator 200 is in the locked position, a force is applied to the button 222 which then transfers the force to the detent 218 and to the biasing member 220 of an aligned one of the apertures 270. The detent 218 is forced completely within the respective one of the apertures 270 directly between and engaging the respective biasing member 220 and an inner end surface of the flange 210 of the second coupling component 204. As such, the first coupling component 202 can freely rotate with respect to the second coupling component 204 until the bore 224 aligns with an adjacent one of the apertures 270 and the detent 218 is biased into the bore 224 and the button 222 extends to the extended position. In some aspects, the first coupling component 202 and the second coupling component 204 may be formed from electroless nickel-plated aluminum for a lightweight, durable, and electrically conductive construction. However, it is understood any suitable material can be employed as desired.

When the retaining member is threaded into the bore 224 and the retaining member 230 engages and maintains the button 222 in a depressed position, the release system 216 is continuously disengaged, permitting continuous free rotation of the first coupling component 202 with respect to the second coupling component 204, regardless of whether the first coupling component 202 is in a locked position. Because the retaining member 230 constantly depresses the button 222, the detent 218 is continuously forced completely within the respective one of the apertures 270 directly between and engaging the respective biasing member 220 and an inner end surface of the flange 210 of the second coupling component 204. This is what allows the hose rotator 200 to operate in a hands-free free-spin mode for as long as required.

To assemble the hose rotator 200, the first coupling component 202 is received in the second coupling component 204. The first coupling component 202 is rotated until the bore 224 and the button 222 align with one of the plurality of apertures 270. Once the bore 224 and the one of the plurality of apertures 270 is aligned, the biasing member 220, which biases towards the flange 206 of the first coupling component 202, forces the detent 218 into the bore 224 to prevent rotation of the first coupling component 202 with respect to the second coupling component 204. The set screw 292 is threaded into the bore 290 and retains the ball bearings 214 within the recesses 294. If it is desired to place the hose rotator in the free-spin mode, the retaining member 230 is threaded fully into the bore 224, allowing the first coupling component 202 continuous free rotation with respect to the second coupling component 204.

In application, the annular extension 250 of the first coupling component 202 is coupled to the hose and the annular extension 260 of the second coupling component 204 is coupled to the fluid outlet 7a of the hose reel 100. The button 222 is maintained in the extended position by the biasing member 227 coupled with the retaining ring 226 unless the button 222 is being forced into the depressed position. Therefore, in order to selectively rotate the hose with respect to the fluid outlet 7a of the hose reel 100, a force, by a user with a finger or tool, for example, is applied to the button 222 to overcome the biasing force of both the biasing member 220 and the biasing member 227. When the force by the user is applied, the button 222 is placed into the depressed position and urges the detent 218 downwardly into the respective aligning one of the apertures 270 to disengage the detent 218 from preventing rotational movement between the first coupling component 202 and the second coupling component 204. The hose rotator 200 is now in the freely rotatable position. The first coupling component 202 can be rotated clockwise or counter-clockwise with respect to the second coupling component 204 at about 60 degrees, or at any interval as desired, until one of the other apertures 270 aligns with the bore 224. Upon the alignment, the biasing member 220 of the adjacent aperture 270 urges the detent 218 into the bore 224 of the first coupling component 202 and the biasing member 227 coupled with the retaining ring 226 causes the button 222 to extend outwardly from the flange 206 of the first coupling component 202 so the first coupling component 202 can be rotated again, if desired.

Alternatively, the retaining member 230 can be threaded into the bore 224 to maintain the button 222 in the depressed position, thereby permitting continuous free rotation of the first coupling component 202 with respect to the second coupling component 204. This free-spin mode facilitates easy hose installation and uninstallation, as the fitting can be spun and threaded onto the hose without having to rotate the entire length of the hose. The free-spin mode also facilitates easy hose inspection by allowing the user to continually rotate the entire hose assembly during inspection.

The hose rotator 200 of the present disclosure provides several advantages. By periodically turning the hose in increments, users can extend overall hose life by distributing outer jacket wear evenly around the entire outer diameter of the hose throughout its life. The free-spin feature allows for easy hose installation and uninstallation. The free-spin ability makes 360 degree hose inspection significantly easier by allowing the user to continually rotate the entire hose assembly during inspection. Additionally, no tools are required to free or turn the swivel and rotate the hose due to the integrated button mechanism.

As a result of the invention of the present disclosure, a hose can be rotated to minimize wear. The hose rotator 200 of the present disclosure permits the second coupling component 204 to remain in one position, without rotational movement, with respect to the fluid outlet of the hose reel 100, while allowing the first coupling component 202 to be rotatable with the hose selectively or periodically, while maintaining consistent fluid communication between the fluid outlet 7a and the hose. For example, as a maintenance task, the first coupling component 202 together with the hose can be rotated 60 degrees every three months to minimize wear and prolong the life of the hose. Although, the hose can be rotated at any time intervals as desired. The hose rotator 200 of the present disclosure is cost effective, simple, and can be fitted and modified to existing hose reels.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A hose rotator, comprising:
a first coupling component;
a second coupling component, wherein the first coupling component is selectively rotatably received in the second coupling component;
a release system configured to selectively disengage a stationary rotational position of the first coupling component with respect to the second coupling component, the release system including a button disposed in a bore of the first coupling component; and
a retaining member selectively receivable in the bore to maintain the button in a depressed position, thereby disengaging the release system and permitting continuous free rotation of the first coupling component with respect to the second coupling component.

2. The hose rotator of claim 1, wherein the first coupling component includes a flange and an annular extension and the second coupling component includes a flange and an annular extension, wherein the annular extension of the first coupling component is axially aligned with and received in the second coupling component.

3. The hose rotator of claim 2, wherein the annular extension of the first coupling component includes an inner threaded portion configured to receive an end of a hose, and the annular extension of the second coupling component includes an outer threaded portion configured to be received in a fluid outlet.

4. The hose rotator of claim 1, wherein the bore includes internal threads and the retaining member is externally threaded configured to be threadably received in the bore.

5. The hose rotator of claim 4, wherein the retaining member includes a head portion and a stem portion, wherein the head portion is configured for manual or tool engagement.

6. The hose rotator of claim 1, wherein the release system further includes at least one detent and at least one biasing member, the at least one biasing member biasing the at least one detent toward the bore to define at least one locked position.

7. The hose rotator of claim 6, wherein the second coupling component includes a plurality of apertures, each of the apertures receiving one of the at least one detent and a corresponding one of the at least one biasing members.

8. The hose rotator of claim 7, wherein the apertures are disposed at equal angular intervals about a flange of the second coupling component.

9. The hose rotator of claim 8, wherein the apertures are disposed at an angle in a range of 30 degrees to 180 degrees from each other.

10. The hose rotator of claim 1, further comprising a plurality of ball bearings disposed between the first coupling component and the second coupling component to facilitate rotation therebetween.

11. The hose rotator of claim 10, further comprising a set screw received in a threaded bore of the second coupling component to retain the ball bearings.

12. The hose rotator of claim 1, further comprising a seal disposed between the first coupling component and the second coupling component.

13. A hose rotator coupling a hose to a fluid outlet, the hose rotator comprising:
a first coupling component configured to receive an end of a hose;
a second coupling component configured to be coupled to a fluid outlet, wherein the first coupling component is received in the second coupling component and is selectively rotatable with respect to the second coupling component between a plurality of locked positions and a freely rotatable position;
a release system having a button cooperating with the first coupling component and the second coupling component to permit selective transition between the plurality of locked positions and the freely rotatable position; and
a retaining member selectively engageable with the first coupling component to maintain the release system in a disengaged state, thereby permitting continuous free rotation of the first coupling component with respect to the second coupling component.

14. The hose rotator of claim 13, wherein the first coupling component includes a flange having a bore, and the retaining member is configured to be received in the bore to maintain the button in a depressed position.

15. The hose rotator of claim 13, wherein the first coupling component includes an annular extension with an inner threaded portion and the second coupling component includes an annular extension with an outer threaded portion.

16. The hose rotator of claim 13, wherein the release system includes a plurality of detents and a plurality of biasing members, each of the biasing members biasing a corresponding one of the detents toward the button of the release system to define the locked positions.

17. The hose rotator of claim 13, further comprising a plurality of ball bearings disposed between the first coupling component and the second coupling component and a set screw configured to retain the ball bearings.

18. The hose rotator of claim 13, further comprising a seal disposed between the first coupling component and the second coupling component.

19. A method of selectively rotating a hose with respect to a fluid outlet, the method comprising:
providing a hose rotator having a first coupling component received in a second coupling component, the hose rotator including a release system with a button and a retaining member;
actuating the button to disengage the release system and permit relative rotation of the first coupling component with respect to the second coupling component;
rotating the first coupling component with respect to the second coupling component; and
selectively engaging the retaining member to maintain the release system in a disengaged state, thereby permitting continuous free rotation of the first coupling component with respect to the second coupling component.

20. The method of claim 19, further comprising disengaging the retaining member from the hose rotator to return the hose rotator to a plurality of locked positions.
